(19) United States
(12) Patent Application Publication
(10) Pub. No.: US 2007/0080212 A1
(43) Pub. Date: Apr. 12, 2007

(54) Systems, methods, and computer-readable media for providing financial accounts with unique characteristics

(75) Inventors: Charles Rosenblatt, Richmond, VA (US); Joseph Wall, Richmond, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/265,111

(22) Filed: Nov. 3, 2005

Related U.S. Application Data
(60) Provisional application No. 60/724,784, filed on Oct. 11, 2005.

(51) Int. Cl. G06K 5/00; G06Q 40/00

(52) U.S. Cl. 235/380; 705/35

(57) ABSTRACT

Systems, methods, and computer-readable media provide mechanisms to provide an additional financial card product to a cardholder or customer at various times during the year. The additional financial card product may be associated with a primary financial card product of the cardholder. In one embodiment, the method may comprise identifying the cardholder, determining a target time to send the additional financial card product to the cardholder, defining one or more attributes associated with the additional financial card product, and sending the cardholder the additional financial card product at the target time.

### RELATED APPLICATION

This application claims the benefit of priority from U.S. Provisional Application No. 60/724,784, entitled “Systems, Methods, and Computer-Readable Media for Providing Financial Accounts with Unique Characteristics,” filed Oct. 11, 2005, the disclosure of which is expressly incorporated herein by reference in its entirety.

### DESCRIPTION

1. Technical Field

The present invention relates generally to the fields of finance and banking. More particularly, the invention relates to computerized systems and methods for providing financial accounts to customers, including an additional financial card product associated with a primary financial card product of a customer, wherein purchases against the additional financial card product are treated more favorably than purchases against the primary financial card product.

2. Background

Credit card products have become so universally well known and ubiquitous that they have fundamentally changed the manner in which financial transactions and dealings are viewed and conducted in society today. Credit card products are most commonly represented by plastic card-like members that are offered and provided to consumers through credit card issuers (such as banks and other financial institutions). With a credit card, an authorized consumer is capable of purchasing services and/or merchandise without an immediate, direct exchange of cash. Instead, the customer incurs debt with each purchase. Thereafter, the customer repays the debt upon receipt of a periodic statement from the issuer. When using the credit card to make a purchase, the transaction is processed via a credit card clearinghouse or authorization system, such as the Visa or MasterCard networks.

In addition to credit cards, there are other financial card products that function like credit cards, but that are associated with a bank account, like a checking account. Such cards are sometimes called check cards. Like credit card purchases, transactions made by using check cards are cleared through a credit card clearinghouse. Debit cards are another type of financial card product. Debit cards are also ordinarily associated with a bank account of some type. A common type of debit card is the automated teller machine (“ATM”) type card. There are also other types of payment cards, such as stored value cards; smart cards; secured cards, where a customer may pay a security deposit before being given the ability to leverage the credit product; and prepaid credit products, where a credit balance is created via prepayment and then utilized at point-of-sale locations.

Credit card issuers and other payment system operators collect a large amount of customer data, some of which is obtained from customers directly. To apply for a credit card, for example, an applicant typically must supply demographic data (e.g., age or city of residence), financial data (e.g., monthly expenses, income, or bank account balance), and employment data (e.g., salary or length of employment). To determine whether to issue a card to the applicant, an issuer may also contact a credit reporting agency to obtain the applicant's credit history.

Often times, credit card issuers may send to customers special financial account products related to new or existing primary credit cards of customers in order to encourage them to use their primary credit cards more often. For instance, credit card issuers may offer customers a primary credit card and a special financial account product with the primary credit card as a vehicle to encourage customers to use their primary credit cards more frequently. One example of a special financial account product is a credit card check. A credit card check is a check providing access to an account holder's credit card line. These credit card checks, however, have many drawbacks. First, each BT check can only be used one time. Second, many merchants do not honor B/T checks. Also, the B/T checks are not sent to customers at specific times during the year, and as a result, many times these B/T checks are ignored or forgotten when they were received. Therefore, the B/T checks provided little or no incentive for the customer to use their primary credit card. As a result, a customer may not be interested in getting a B/T check and, therefore, may not be interested in an offer for B/T checks associated with a primary credit card.

In view of the foregoing, there is a need for improved systems, methods, and computer program products for providing and managing financial accounts that include offering a customer an additional financial product associated with the customer's primary financial card (new or existing), wherein the additional financial product is sent at various target times during the year, can be used more than once for purchase and is accepted by a wider range of merchants.

### SUMMARY

Systems, methods, and computer-readable media consistent with the present invention address these and other needs by providing a financial account to a customer, wherein the financial account includes an additional financial card product associated with a primary financial card product of the customer. The additional financial card product may be sent at various target times during the year to the customer and may include special account terms, including special terms to be applied toward transactions made using the additional financial card product.

In accordance with one embodiment, a method is provided that comprises identifying the cardholder, determining a target time to send the additional financial card product to the cardholder, defining one or more attributes associated with the additional financial card product, and sending the cardholder the additional financial card product at the target time.

Consistent with another embodiment, a system is disclosed for providing an additional financial card product to a cardholder, wherein the additional financial card product is associated with a primary financial card product of the cardholder. The system may comprise a component for identifying the cardholder, a component determining a target time to send the additional financial card product to the cardholder, a component defining one or more attributes associated with the additional financial card product, and a component sending the cardholder the additional financial card product at the target time.

In yet another embodiment, a computer-readable medium is provided that stores a set of instructions, which, when executed, performs a method for providing an additional financial card product to a cardholder, wherein the additional financial card product is associated with a primary financial card product of the cardholder. The method may comprise identifying the cardholder, determining a target time to send the additional financial card product to the cardholder, defining one or more attributes associated with the additional financial card product, and sending the cardholder the additional financial card product at the target time.

It is to be understood that both the foregoing general summary and the following detailed description are exemplary and explanatory only, and are not restrictive of the invention, as claimed. Further features and/or variations may be provided in addition to those set forth herein. For example, the present invention may be directed to various combinations and subcombinations of the disclosed features, and/or combinations and subcombinations of several further features disclosed below in the detailed description.

### BRIEF DESCRIPTION OF THE DRAWINGS

The accompanying drawings, which are incorporated in and constitute a part of this specification, illustrate various embodiments of the present invention and, together with the description, serve to explain the principles of the invention. In the drawings:

FIG. 1 is a schematic illustration of an exemplary system environment 100, consistent with an embodiment of the present invention;

FIG. 2 is a flow chart of an exemplary method for providing and managing financial accounts, consistent with an embodiment of the present invention; and

FIG. 3 is a flow chart of an exemplary method for customizing a financial account, consistent with an embodiment of the present invention.

### DETAILED DESCRIPTION

Reference will now be made in detail to exemplary embodiments consistent with the invention, examples of which are illustrated in the accompanying drawings. Wherever possible, the same reference numbers will be used throughout the drawings to refer to the same or like parts.

The following detailed description refers to the accompanying drawings. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the scope of the invention.

Embodiments consistent with the present invention are directed to methods, systems, and computer program products for providing financial products, such as credit card products, with unique characteristics. As further disclosed herein, financial card products may be provided at target times during the year that enable customers to obtain greater benefits for purchases made with the financial card product. The financial card product may be associated with a customer's primary financial card product, such as the customer's primary credit card.

Embodiments consistent with the invention may be implemented in various environments, including computer-based environments, such as personal computers, workstations, servers, laptops, personal digital assistants (PDAs), mobile phones, hand-held devices, and other computing devices; and workstation, networked, and other computing-based environments with one or more customers. The present invention, however, is not limited to such examples, and embodiments consistent with the invention may be implemented with other platforms and in other environments.

By way of example, embodiments consistent with the invention may be implemented using conventional personal computers (PCs), desktops, hand-held devices, multiprocessor computers, pen computers, microprocessor-based or programmable consumer electronics devices, minicomputers, mainframe computers, personal mobile computing devices, mobile phones, portable or stationary personal computers, palmtop computers, or the like.

The storage media referred to herein symbolize elements that temporarily or permanently store data and instructions. Although storage functions may be provided as part of a computer, memory functions can also be implemented in a network, processors (e.g., cache, register), or elsewhere. Various types of storage media can be used to implement features of the invention, such as a read-only memory (ROM), a random access memory (RAM), or a memory with other access options. Further, memory functions may be physically implemented by computer-readable media, such as, for example: (a) magnetic media, like a hard disk, a floppy disk, a magnetic disk, a tape, or a cassette tape; (b) optical media, like an optical disk (e.g., a CD-ROM), or a digital versatile disk (DVD); or (c) semiconductor media, like DRAM, SRAM, EPROM, EEPROM, memory stick, and/or by any other media, like paper.

Embodiments consistent with the invention may also include computer program products that are stored in a computer-readable medium or transmitted using a carrier, such as an electronic carrier signal communicated across a network between computers or other devices. In addition to transmitting carrier signals, network environments may be provided to link or connect components in the disclosed systems. Networking environments are commonplace in offices, enterprise-wide computer networks, Intranets, and the Internet (i.e., the World Wide Web). The network may be a wired or a wireless network. To name a few network implementations, the network may be, for example, a local area network (LAN), a wide area network (WAN), a public switched telephone network (PSTN), an Integrated Services Digital Network (ISDN), an infrared (IR) link, a radio link, such as a Universal Mobile Telecommunications System (UMTS), a Global System for Mobile Communication (GSM), Code Division Multiple Access (CDMA), or a satellite link.

Systems, methods, and computer program products consistent with the present invention may provide financial card products, such as credit card products, to new or existing customers of credit card issuers and other financial institutions at target times during the year. Consequently, systems, methods, and computer program products consistent with the present invention may enable a customer to obtain greater benefits for purchases made using the financial card products. More specifically, systems, methods, and computer program products consistent with the present invention may provide, at target times during the year, an additional financial card product associated with a primary financial card product of the customer, where purchases made with the additional financial card product are treated more favorably than purchases made with the primary financial card product.

For purposes of illustration, exemplary financial accounts of the present invention are described with reference to credit card accounts. However, those of skill in the art will recognize that the present invention may also be used with respect to other types of financial accounts or products, such as checking accounts (check cards), debit accounts (debit cards), and other types of cards offered by financial account institutions, credit card companies, banks, and the like. Furthermore, exemplary financial card products are described herein with reference to credit card products. However, those skilled in the art will recognize that the invention may also be used with check card products, debit card products, and other financial card products offered by financial account institutions, credit card companies, banks, and the like.

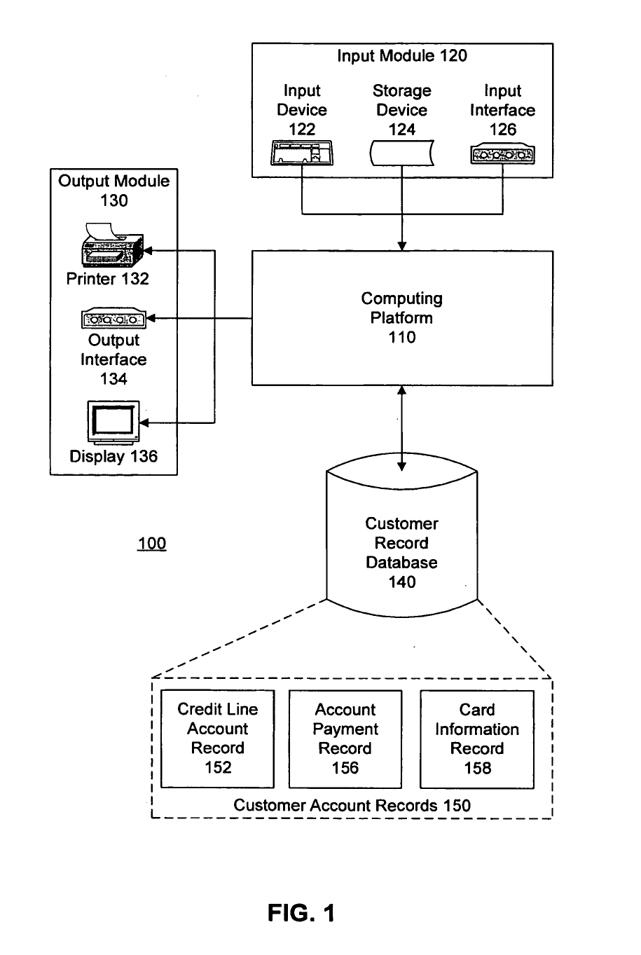

FIG. 1 illustrates an exemplary system environment 100, consistent with an embodiment of the present invention. As illustrated in FIG. 1, issuer 100 includes a computing platform 110, an input module 120, an output module 130, and a customer record database 140. Computing platform 110 is adapted to process information received from input module 120. Computing platform 110 is further adapted to provide information to output module 130. Additionally, computing platform 110 is adapted to access information in customer record database 140 for use in performing methods consistent with the present invention, as discussed below.

Computing platform 110 preferably comprises a general purpose computer (e.g., a personal computer, network computer, server, or mainframe computer) having a processor that may be selectively activated or reconfigured by a computer program to perform one or more methods consistent with the present invention. Computing platform 110 may also be implemented in a distributed network. Alternatively, computing platform 110 may be specially constructed for carrying out methods consistent with the present invention.

Input module 120 may include an input device 122, a storage device 124, and/or an input interface 126. Input device 122 may be implemented using a keyboard, mouse, speech recognition device, or other user interface adapted for data entry. Storage device 124 may include a memory, such as RAM or ROM memory, that contains instructions or data for performing one or more methods consistent with the present invention. Computing platform 110 may link storage device 124 to input interface 126. Input interface 126 may in turn be linked to a device (not shown), such as a disk drive or the Internet, for transferring instructions from a computer-readable medium to the storage device 124 for later execution by the computing platform 110.

Consistent with the present invention, a computer-readable medium is any type of medium that is capable of carrying information that may be used to configure computing platform 110 to perform methods consistent with the present invention. The computer-readable medium may be, for example, a physical medium (e.g., a punch card), a magnetic medium (e.g., a magnetic disk or tape), an optical medium (e.g., an optical disk), or a carrier wave (e.g., from a computer network, such as the Internet). The computer-readable medium may be encoded with instructions for configuring the computing platform to perform one or more methods consistent with the present invention. The computer-readable medium may also contain data used in such methods.

In creating a new financial account, input module 120 may be used to enter or obtain information about a customer and/or attributes of the customer's accounts. This information may be obtained, for example, from the customer, from storage device 124, or from a computer-readable medium, such as a disk drive or carrier wave, via input interface 126. After a new account has been created, input module 120 may be used to enter or obtain information about transactions made by the customer using the account. Computing platform 110 may then store the information received for input module 120 in customer record database 140.

As described below, computing platform 110 uses the stored account information to manage the customer's account using methods consistent with the present invention. Computing platform 110 also provides account information generated by computing platform 110 or obtained from customer record database 140 to output module 130. Output module 130 in turn outputs the received information to the customer or to customer service representatives for use internally or for assisting the customer.

Output module 130 may include a printer 132, an output interface 134, and/or a display 136. Printer 132 may be used to provide a conventional billing statement to the customer. Output interface 134 may provide billing and other information to the customer via the Internet in the form of an online account statement, or save the information on a computer-readable medium. Display 136 may provide account information to customer service representatives who may assist the customer via telephone.

Customer record database 140 may be used to store customer account records 150. Customer account records 150 preferably include the customer's identifying information, such as the customer's name, billing address, telephone number, and/or Social Security number, etc. Customer account records 150 may also include other information about the customer, such as the customer's credit rating, credit history, and demographic information.

Customer account records 150 preferably also include a credit line account record 152 and an account payment record 156. The information contained in these records corresponds to information contained in, for example, an account agreement between the customer and the issuer that governs the terms of the account. These records may also contain information corresponding to transactions made by the customer using the account. The information to be entered in records 150, 152, and 156 may be entered or obtained using input module 120.

Credit line account record 152 may store information regarding credit line account transactions of a customer. Transaction information may include information for each transaction, such as the date of a purchase, the merchant's name, the merchant's city and state, the merchant type, as well as the types of merchandise purchased at the merchant. Credit line account record 152 may also include information about the current credit line balance and the amount of credit currently available to the customer.

Account payment record 156 stores information concerning payments made to the issuer by the customer. This information may include information indicating the date a payment was made on the account. Account payment record 156 may also include information indicating the number of times a payment has been late on the account. Account payment record 156 may also include a summary of each payment on the account. For example, account payment record 156 may include information indicating, for each month, the date the payment was due and the actual date the payment was received.

Card information record 158 may store information related to the various accounts for a customer. Card information record 158 may also store the attributes of the credit line account for each credit card account associated with a customer, such as: the credit limit, the grace period on purchases, minimum credit line purchase requirements, the interest rate on the credit line account, the minimum payment on the credit line account, conditions for modification of the credit line account attributes, and/or information on rewards, e.g., cash back, used to encourage purchases using the credit line account.

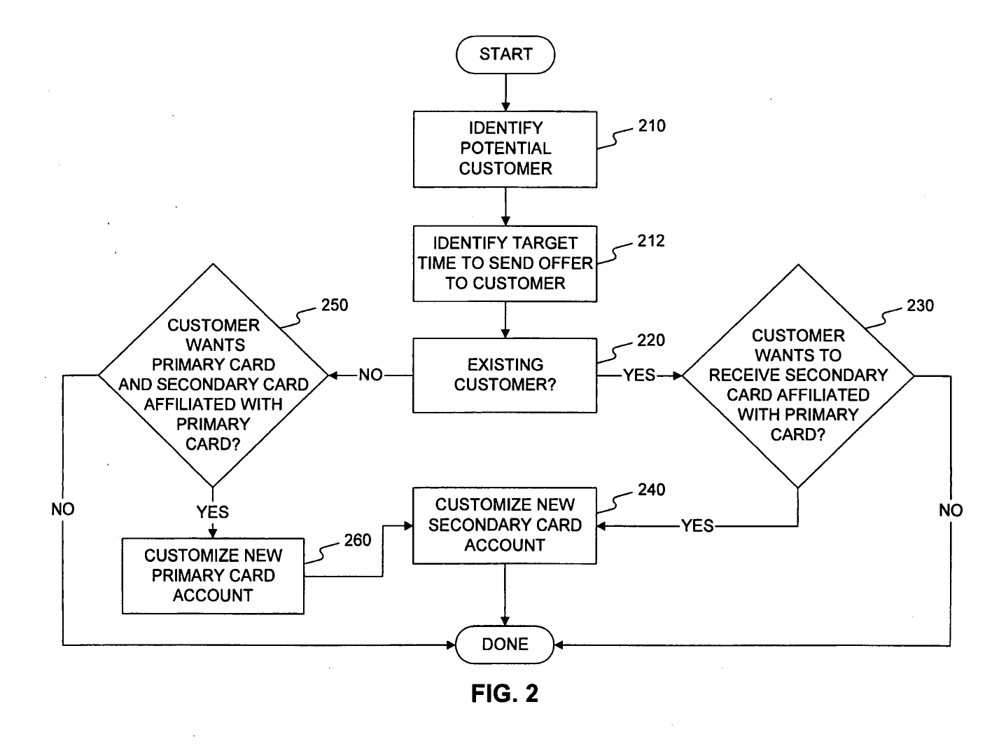

By way of example, FIG. 2 illustrates a flow chart of an exemplary method for providing and managing financial accounts, consistent with an embodiment of the present invention. While exemplary methods of the present invention are described as a series of acts, the order of the acts may vary in other implementations, consistent with the present invention. In particular, nondependent acts may be performed in any order or in parallel. Providing and managing a financial account may involve identifying a customer (either new or existing), offering the financial account to the customer, customizing or changing the terms and conditions of the account (depending on whether the account is a new account or an existing account) for the customer, and communicating the attributes of the account to the customer.

Identifying a customer (stage 210) may be done in a number of ways. A potential customer may be identified based on customer characteristics believed to indicate that the customer would be sufficiently likely to respond to an offer of an account consistent with the present invention. For example, a customer who is identified as having previously been issued a B/T check, and having used the B/T check, may be identified as a candidate for an account consistent with the present invention. Additionally, or alternatively, a customer who shows a change in usage behavior of an existing account may be identified as a candidate. For example, a customer who reduces spending on an existing account, or stops using an existing account may be identified for sending an offer for an account. A customer that has reached an account behavior threshold may also be sufficiently likely to respond to an offer of an account consistent with the present invention. For example, the customer may have made six months of continuous payments on an existing account. A customer that has a new address (recently moved to a new residence or bought a new home) may also be likely to respond to an offer of an account consistent with the present invention.

After a potential customer is identified, issuer 100 may then determine various target times during the year to send an offer consistent with the present invention to the customer (stage 212). Issuer 100 may rely on a number of factors in determining the various times the additional credit card product may be offered. These factors may include customer purchasing behavior, a change in usage behavior of an existing account (e.g., customer stops using the existing account), when a customer has reached an account behavior threshold (e.g., the customer has made a year of on time payments), or when an existing customer reports a change of address to the Issuer. In one embodiment, the additional credit card product offer may only be sent to a customer during various holiday seasons or around the time of the cardholder's birthday. Other examples of target times to send the offer include back-to-school periods, medical emergencies, tax payments or seasons, new homeowner status, household changes (child born, child goes to college, child turns 16 or 18), or during the summer months.

After the various target times are identified, issuer 100 may determine whether the customer is an existing customer with the issuer (stage 220). If the customer identified in stage 220 is an existing customer, issuer 100 may search customer record database 140 (see FIG. 1). This search may be performed to locate the customer's financial account and present the existing customer with an offer for an additional or secondary credit card product on the existing account based on the customer's primary credit card. The additional credit card product may include attributes such that purchases made with the additional credit card product are treated more favorably than purchases made with the primary credit card. Issuer 100 may send the customer an offer to receive the additional credit card product with a billing statement and, based on the customer's response, determine whether the customer wants to receive the additional credit card product (stage 230). The customer's response may be provided on the billing statement portion sent with payment back to the issuer or may be communicated by other means (e.g., a response card, a telephone call, an email, etc.). If the existing customer accepts the offer, issuer 100 may then customize the terms and conditions of the additional credit card product for the existing customer (stage 240), as described below. In one embodiment, the terms and conditions of the additional credit card product may be customized for the particular customer, before and/or after the initial offer is communicated to the customer, and presented to the customer in a customized offer.

If issuer 100 determines in stage 220 that the customer is a new customer, issuer 100 may send the customer an offer to receive a primary credit card product as well an additional or secondary credit card product associated with the primary credit card product. Based on the new customer's response, issuer 100 may determine whether the customer is interested in receiving the additional credit card product and the primary credit card product (stage 250). If the offer is accepted, issuer 100 may then customize the terms and conditions of the new primary credit card product (stage 260) and the additional credit card product (stage 240) for the particular customer, as described below. In one embodiment, the terms and conditions of the additional credit card product may be customized for the particular customer, before and/or after the initial offer is communicated to the customer, and presented to the customer in a customized offer.

As shown in FIG. 1, computing platform 110 may be used to define or otherwise customize the attributes of the account for a particular customer. Input module 120 may be used to gather identifying information about a particular customer, as well as information concerning the particular customer's credit history and the spending habits, etc. This information may be available from the customer or from another source, such as a financial database or one of the customer's existing creditors. Computing platform 110 may use the customer's identifying information to determine the account attributes of the additional credit card product.

The terms and conditions of the new or existing account may inform the customer of an offer to receive, at target times during the year, an additional or secondary credit card product associated with a primary credit card product, where purchases made with the additional credit card product are treated more favorably than purchases made with the primary credit card product. In one embodiment, the additional credit card product may share a common credit line with the primary credit card product. In yet another embodiment, the additional credit card product may have a credit limit based on the credit limit of the primary credit card product. In yet another embodiment, the additional credit card product may have various limitations on usage. The different embodiments as well as the features and attributes of the additional credit card product are discussed in greater detail below.

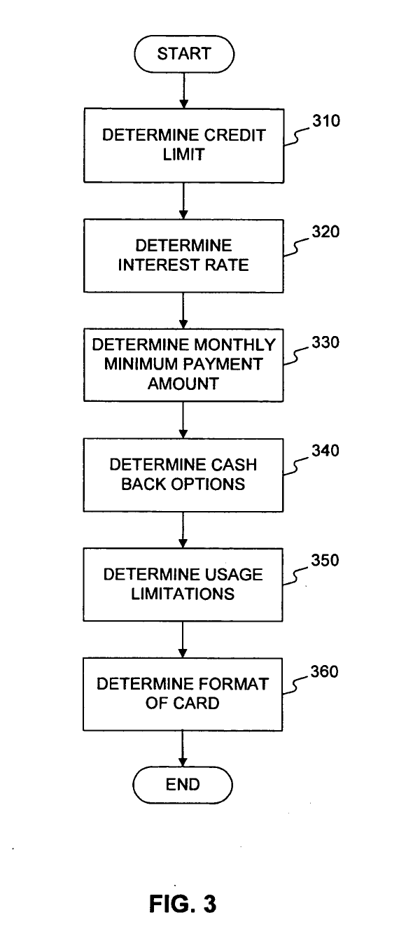

FIG. 3 illustrates an exemplary method of customizing a financial account, consistent with an embodiment of the present invention. Customization may be performed for each individual customer. Additionally, or alternatively, each customer may be assigned to a customer group or profile, and the financial account for the customer may be customized according to the terms and attributes that are deemed applicable to the assigned customer group or profile.

In one embodiment, issuer 100 may use the purchasing behavior of the customer to determine the various terms and attributes of the additional credit card product. Issuer 100 may also use the information stored about the customer in customer record database 140 (see FIG. 1) to define the various terms and attributes. For example, issuer 100 may use the information regarding the credit line account transactions of a customer stored in credit line account record 152 (see FIG. 1) to determine the interest rate, the amount of cash back, or whether the additional credit card product may be associated with a no minimum monthly payment attribute.

In accordance with one embodiment, the account attributes of the additional credit card product may include the credit limit, the interest rate, minimum monthly payment options, cash back options, usage limitations, and/or various times the additional credit card product may be offered to a customer.

Issuer 100 may rely on a number of factors in determining the credit limit, the interest rate, minimum payment options, cash back options, usage limitations, and various times the additional credit card product may be offered. One factor may be whether the customer is in good standing. For example, if a customer has been in good standing for more than one year, issuer 100 may determine to set a lower interest rate on the customer's additional credit card product. A customer may be considered to be in good standing if he/she has made a predetermined number of minimum payments within a predetermined time. For example, if a customer has made six consecutive monthly payments, or if a customer has made eleven of the last twelve minimum payments, then the customer may be determined to be in good standing. A customer may also be considered to be in good standing if the customer has stayed within his credit limit or has not exceeded the credit limit for a predetermined period of time, for example, one year.

Other factors issuer 100 that may be relied upon to determine the credit limit, the interest rate, minimum payment options, cash back options, usage limitations, and/or various times the additional credit card product may be offered include the level of usage of an existing account or the percentage of the credit limit that the customer has used. For example, if a customer has $500 outstanding balance and a $1000 credit limit on an existing account, then the customer has a 50% usage, and issuer 100 may rely on this factor to determine the credit limit etc. of the new credit card product. Another factor may be the customer profitability measure, a comparison of interchange and interest payments vs. current assets of risk/charge off profitability. For example, if a customer may create $50 in additional income for Issuer 100 (projected) and the customer may have a 10% chance of charge-offs with a $1000 credit limit, Issuer 100 may not want to encourage usage, since the customer may be more costly than profitable. Yet another factor may include types of purchases the customer makes (e.g., small value vs. large value or whether the purchases are at certain retail establishments).

Referring again to FIG. 3, issuer 100 may first set the credit limit of the additional credit card product (stage 310). In one embodiment, the primary credit card product and the additional credit card product may be affiliated or share a common credit line. For example, both the primary credit card product and the additional credit card product may share a $5000 credit limit. In another embodiment, issuer 100 may determine the credit limit of the additional credit card product based on the credit limit of the primary credit card product. For instance, the credit limit of the additional credit card product may be a predetermined percentage of the primary credit card product. Thus, if the credit limit of the primary credit card product is $2,000 and the predetermined percentage basis is 50%, then issuer 100 may set the credit limit for the additional credit card product to be half of $2,000 (i.e., a $1,000 credit limit). In yet another embodiment, the additional credit card product may have a credit limit that is lower than the credit limit of the primary credit card.

Issuer 100 may also customize the interest rate to apply to purchases made using the additional credit card product (stage 320). In one embodiment, the additional credit card product may be associated with a lower interest rate than the primary credit card product. In another embodiment, the additional credit card product may be set according to a market rate or may not be associated with any interest rate.

Issuer 100 may also determine the monthly minimum payment amount for the additional credit card product (stage 330). In one embodiment, issuer 100 may set the additional credit card product to have a no monthly minimum payment attribute where a customer may not be required to make a minimum monthly payment on purchases made using the additional credit card product for a period of time as determined by Issuer 100.

Issuer 100 may also determine different reward options to be associated with the additional credit card product for the customer (stage 340). Reward options may comprise of airlines miles and reward points, where the miles and points are based on card usage where the customer qualifies for a benefit. By way of example, issuer 100 may determine that a customer can receive a certain amount of cash back if the customer uses the additional credit card product. For example, issuer 100 may determine that a customer may receive 5% cash back on all purchases made using the additional credit card product. In another example, issuer 100 may determine that a customer receives a predetermined amount of airline miles with every purchase made using the additional credit card product.

Further, issuer 100 may determine various limitations on usage for the additional credit card product (stage 350). In one embodiment, the additional credit card product may be associated with a time-based expiration. For example, issuer 100 may determine that the additional credit card product can only be used for six months and, after six months, the customer can no longer use the credit card product. In another embodiment, the additional credit card product may also be associated with a transaction-based expiration. For example, issuer 100 may determine that the additional credit card product may only be used for a total of five transactions. In yet another embodiment, the additional credit card product may also be associated with an amount-based expiration. For example, issuer 100 may determine the additional credit card product may only have a $500 amount limit. The amount-based expiration is a total amount of credit available for purchases against the credit card product.

Issuer 100 may also determine the format of the additional credit card product (stage 370). In one embodiment, the additional credit card product may be in the form of a regular credit card. In another embodiment, the additional credit card product may be a smaller version of a regular credit card, for example, to be able to fit on a keychain. In yet another embodiment, the additional credit card product may be co-branded with one or more merchants or may be themed to commensurate the targeted time (e.g., decorated in a Christmas holiday theme).

Other account terms may be determined or customized for the additional credit card product. In one embodiment, issuer 100 may set special account terms such as specialized or separate billing statements or periods for the additional credit card product.

Once the terms and conditions of the account are initially customized, the offer may then be communicated to the customer in a numerous ways, e.g., via electronic mail, regular mail, an Internet Web page, telephone, or media advertisement. For example, an issuer may contact an existing customer via phone to inquire whether the customer would like to receive the additional credit card product. Once the existing customer accepts the offer, the new terms may be memorialized in the existing account agreement. In another example, an issuer may contact a potential customer via electronic mail to inquire whether the customer would like to open an account where the customer receives an additional credit card product, as well with terms and conditions that are more favorable than the primary credit card. Once the new customer accepts the offer, a new account may be opened and the terms may be memorialized in an account agreement that will govern the attributes of the account.

Although embodiments of the present invention have been described based on the system environment shown in FIG. 1, one skilled in the art will realize that various other configurations may be employed by methods, systems, and computer program products consistent with certain principles related to the present invention without affecting its scope.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims. For example, the process steps shown in the drawings are not limited to the sequences described above. Variations of these sequences, such as the removal and/or the addition of other process steps may be implemented without departing from the spirit and scope of the present invention.

What is claimed is:

1. A computerized method for providing an additional financial card product to a cardholder, wherein the additional financial card product is associated with a primary financial card product of the cardholder, comprising:
identifying the cardholder;
determining a target time to send the additional financial card product to the cardholder;
defining one or more attributes associated with the additional financial card product; and
sending the cardholder the additional financial card product at the target time.

2. The method of claim 1, wherein the determination of the target time to send the additional card product to the cardholder further comprises:
analyzing purchasing behavior of the cardholder; and
determining the target time based on the purchasing behavior.

3. The method of claim 1, further comprising:
defining a first credit limit for the additional financial card product, wherein the first credit limit is based on a percentage of a second credit limit of the primary financial card product.

4. The method of claim 1, wherein defining the one or more attributes further comprises:
analyzing purchasing behavior of the cardholder; and
defining the one or more attributes based on the purchasing behavior.

5. The method of claim 1, wherein the one or more attributes include at least one of a first interest rate to apply against purchases made using the additional financial card product, a monthly minimum payment amount, a cash back option, one or more usage limitations, and a format of the additional financial card product.

6. The method of claim 5, wherein the first interest rate of the additional financial card product is lower than a second interest rate of the primary financial card product.

7. The method of claim 5, wherein the one or more usage limitations include at least one of a time-based limitation, a transaction-based limitation, and an amount-based limitation.

8. The method of claim 1, wherein the additional financial card product is one of a credit card, a debit card, or a check card.

9. The method of claim 1, wherein the primary financial card product is a credit card.

10. The method of claim 1, wherein the target times includes one of the cardholder's birthday, a back-to-school period associated with the cardholder, a medical emergency associated with the cardholder, a tax season, or during a new homeowner status associated with the cardholder.

11. The method of claim 5, wherein the transaction-based limitation is a maximum number of transactions the additional financial card product can be used by the cardholder.

12. A system for providing an additional financial card product to a cardholder, wherein the additional financial card product is associated with a primary financial card product of the cardholder, comprising:
a component for identifying the cardholder;
a component determining a target time to send the additional financial card product to the cardholder;
a component defining one or more attributes associated with the additional financial card product; and
a component sending the cardholder the additional financial card product at the target time.

13. The system of claim 12, wherein the determination of the target time to send the additional card product to the cardholder further comprises:
a component for analyzing purchasing behavior of the cardholder; and
a component for determining the target time based on the purchasing behavior.

14. The system of claim 12, further comprising:
a component defining a first credit limit for the additional financial card product, wherein the first credit limit is based on a percentage of a second credit limit of the primary financial card product.

15. The system of claim 12, wherein defining the one or more attributes further comprises:
a component for analyzing purchasing behavior of the cardholder; and
a component for defining the one or more attributes based on the purchasing behavior.

16. The system of claim 12, wherein the one or more attributes include at least one of a first interest rate to apply against purchases made using the additional financial card product, a monthly minimum payment amount, a cash back option, one or more usage limitations, and a format of the additional financial card product.

17. The system of claim 16, wherein the first interest rate of the additional financial card product is lower than a second interest rate of the primary financial card product.

18. The system of claim 16 wherein the one or more usage limitations include at least one of a time-based limitation, a transaction-based limitation, and an amount-based limitation.

19. The system of claim 12, wherein the additional financial card product is one of a credit card, a debit card, or a check card.

20. A computer-readable medium that stores a set of instructions which, when executed, performs a method for providing an additional financial card product to a customer, wherein the additional financial card product is associated with a primary financial card product of the customer, comprising:
identifying the cardholder;
determining a target time to send the additional financial card product to the cardholder;
defining one or more attributes associated with the additional financial card product; and
sending the cardholder the additional financial card product at the target time.
